(19) United States
(12) Patent Application Publication
(10) Pub. No.: US 2024/0402381 A1
(43) Pub. Date: Dec. 5, 2024

(54) METHOD FOR IDENTIFYING ALARM OBJECTS IN ITEMS OF LUGGAGE BY MEANS OF A PRIMARY IDENTIFICATION SYSTEM AND A SECONDARY IDENTIFICATION SYSTEM

(71) Applicant: SMITHS DETECTION GERMANY GMBH, Wiesbaden (DE)

(72) Inventors: Jens-Peter SCHLOMKA, Hamburg (DE); Stephan OLESINSKI, Hamburg (DE); Dirk STRECKER, Pinneberg (DE); Gabriel ZIENERT, Hamburg (DE); Holger FLECKENSTEIN, Bönningstedt (DE); Stephan REIN, Hamburg (DE); Daniel HIRSCHMEIER, Hamburg (DE)

(21) Appl. No.: 18/688,115

(22) PCT Filed: Aug. 30, 2022
(86) PCT No.: PCT/EP2022/074020

§ 371 Date: Feb. 29, 2024

(30) Foreign Application Priority Data
Aug. 31, 2021 (DE) 102021209561.5

(51) Int. Cl. G01V 5/222

(52) U.S. Cl. CPC G01V 5/222

(57) ABSTRACT

The present disclosure relates to a method for detecting alarm objects in items of luggage using a primary detection system and a secondary detection system, having the following steps: carrying out a primary detection method by means of the primary detection system to detect at least one alarm object, transferring at least one alarm object parameter (AP) to the secondary detection system in the event of an alarm object being detected in the primary detection method, adapting at least one detection parameter (DP) of the secondary detection system on the basis of the alarm object parameter (AP), carrying out a secondary detection method by means of the secondary detection system with adapted at least one detection parameter (DP) in order to check the alarm object detected in the primary detection method, and outputting an alarm signal (AS) in the event that the checking of the alarm object proves positive.

### CROSS-REFERENCE TO RELATED APPLICATIONS

The present application is a national stage entry of International Application No. PCT/EP2022/074020, filed Aug. 30, 2022, which claims priority to DE 10 2021 209 561.5, both of which are incorporated herein by reference in their entirety.

### BACKGROUND

The present disclosure relates to a method for detecting alarm objects in items of luggage by means of a primary detection system and a secondary detection system, a computer program product for carrying out such a method and a detection device for carrying out a method according to the disclosure.

It is known that, in security-relevant areas, items of luggage need to be checked for alarm objects. An example of such a sensitive area is the security area of an airport. Before entering the security area, passengers' hand luggage is scanned. In the same way, before baggage is loaded into the cargo hold of the aircraft, checked baggage is also checked to see if it contains alarm objects.

Alarm objects can take a wide variety of forms. For example, alarm objects can be objects that could endanger the safety of flight operations. These can be explosives, for example. However, other objects can also be defined as alarm objects. For example, prohibited materials, for example narcotics or other contraband, can be prevented from being loaded onto the aircraft as alarm objects.

For this purpose, known solutions are usually equipped with detection systems which have, for example, a computer tomography (CT) screening functionality. However, it is known that such detection systems can exhibit different weak points depending on the actual technical design. Furthermore, it is also known for different detection systems to be combined. For example, a computer tomography method can be used as a primary detection system and supplemented by a secondary detection system with different detection functionality. The disadvantage of these solutions is that, often, at least one of the different detection systems has a significantly reduced detection speed. Since, in the known solutions, all items of luggage, for example in an airport baggage handling system, often have to be conveyed through all detection systems, the slowest detection system therefore determines the maximum conveying speed.

Although it is already known for a second detection step to be skipped if no alarm object is found in the first detection step, this still leads to the majority of items of luggage undergoing a secondary check in the secondary detection system and thus to a reduced number of checked items of luggage per unit of time.

### BRIEF DESCRIPTION

The embodiments described herein remedy, at least in part, the problems described above. In particular, the embodiments described herein increase the speed of detection of alarm objects in items of luggage in a cost-effective and simple manner and at the same time to reduce the output of false alarms.

This achieved by a method with the features of claim 1, a computer program product with the features of claim 14 and a detection device with the features of claim 15. Further features and details of the disclosure are disclosed in the dependent claims, the description and the drawings. Naturally, features and details described in connection with the method also apply in connection with the computer program product and the detection device and vice versa, so that mutual reference is or can always be made with respect to the individual aspects of the disclosure.

According to the disclosure, a method is used to detect alarm objects in items of luggage. To this end, the method uses a primary detection system and a secondary detection system and has the following steps:
carrying out a primary detection method by means of the primary detection system to detect at least one alarm object;
transferring at least one alarm object parameter to the secondary detection system in the event of an alarm object being detected in the primary detection method,
adapting at least one detection parameter of the secondary detection system on the basis of the alarm object parameter,
carrying out a secondary detection method by means of the secondary detection system with adapted at least one detection parameter in order to check the alarm object detected in the primary detection method;
outputting an alarm signal in the event that the checking of the alarm object proves positive.

In particular, a method according to the disclosure builds on known solutions and uses a two-step detection method. As will be explained later, this two-stage detection method is based in particular on different detection functionalities. For example, a computer tomography system can be used as a primary detection system. An X-ray diffraction system can for example be used as a secondary detection system.

In a similar way to known solutions, in a method according to the disclosure a detection of an alarm object is carried out in the primary detection system. As soon as an alarm object is detected, at least one alarm object parameter is determined, which can for example include the location, the type, a material property or the geometric extension of the alarm object in the item of luggage. Of course, two or more alarm object parameters can also be used within the scope of the present disclosure. The simplest transfer of an alarm object parameter is the qualitative presence or absence of an alarm object in the item of luggage.

Whereas, in known methods, the second secondary detection system has now checked the alarm object on the basis of an alarm object being present, the method according to the disclosure goes further. For example, the way the secondary detection method is carried out can be adapted to the situation of the outcome of the primary detection method. For this purpose, at least one detection parameter of the secondary detection system is adapted on the basis of the alarm object parameter. Examples can include technical settings of the secondary detection system, as will be explained in more detail later. The adapted detection parameter influences the performance of the detection method. In other words, a change in the detection parameter achieves a technical change for the performance of the secondary detection method, so that the detection result based on the changed detection parameter differs accordingly from a detection result without such a change. In particular, this serves to improve detection or, if the alarm object situation allows this, to reduce the accuracy of checking with the help of the secondary detection method. This step therefore makes it possible not only to perform or omit the secondary detection method, but also, when performing this, to adapt the way in which it is performed to at least one alarm object parameter. The aim of this adaptation is, in particular, to influence the speed of the secondary detection method and thus to ensure as far as possible the minimum adequate detection and/or verification accuracy for the alarm object, making it possible to perform the secondary detection method at the maximum speed, depending on the situation.

As can be seen from the explanation above, the duration for the secondary detection method is not statically predetermined, but rather varies on the basis of the adaptation of at least one detection parameter. Depending on the verification situation, which in turn depends on the detection situation of the primary detection method, the secondary detection method can now be carried out more slowly or more quickly.

While, in the known solutions, the secondary detection method was always carried out at the same speed, a significant increase in speed can now be achieved in at least some of the scans carried out with the help of the secondary detection. Over the overall operation of a detection device when carrying out a method according to the disclosure, the limitation of the speed can thus be optimised, since at least some of the items of luggage selected for secondary detection can be processed with a higher detection speed than is the case with the known solutions. Alternatively or additionally, an optimisation of the detection accuracy can also be achieved. For example, it is possible to extend the duration of the secondary detection method for specific individual items of luggage in order to ensure a more accurate analysis. While this results in unchanged or even longer throughput times, it reduces the number of false alarms.

It therefore becomes possible always to apply exactly the minimum necessary detection accuracy in the secondary detection method so that, accordingly, the maximum possible detection speed can be achieved for each verification situation of an alarm object from the primary detection method. The overall speed, which is expressed in particular in the total throughput of items of luggage, can thus be significantly increased using a method according to the disclosure.

It should also be noted that the secondary detection system may differ in terms of its detection functionality from the detection functionality of the primary detection system. For example, a computer tomography scanner can be used as a primary detection system and an X-ray diffraction analysis can be performed as a secondary detection system. The different functions thus also lead to different detection possibilities, so that in addition to increasing the speed, the method according to the disclosure can detect and verify alarm objects while maintaining or even increasing reliability. In addition to the increase in speed, this increased reliability also leads to a reduction in the false alarm rate, i.e. the undesirable generation of an alarm signal as a result of an incorrectly detected alarm object. In particular, it is possible to vary the detection parameter in a targeted manner in order to obtain the best possible value at the highest possible speed in the case of a so-called ROC correlation between detection rate and number of false alarms. In this way, it is also possible to actively switch between different ROC curves.

As soon as a verification check using the secondary detection method has resulted in a confirmation of the alarm object from the primary detection method, an alarm signal is output in the last step of a method according to the disclosure. In the event of the check proving negative, this item of luggage is defined as being free of the alarm object and released for further processing. On the basis of the alarm signal generated, the item of luggage can be diverted and conveyed to a separate inspection room for manual and/or visual inspection. A visual inspection may also include a review by the operating personnel of the detection data from the two detection systems. In the event of a risk, however, in addition to or as an alternative to checking the detection results on surveillance screens, it may be necessary to open the suitcase manually and search this item of luggage manually.

It can be advantageous if, in a method according to the disclosure, in the primary detection system and in the secondary detection system the items of luggage are scanned by means of electromagnetic radiation. Scanning with electromagnetic radiation leads to different detection accuracies and, in particular, to the possibility of registering the content, condition, size and shape and/or material properties of individual objects contained in the item of luggage in more detail. As has already been explained, both detection systems may be equipped with electromagnetic radiation sources, but in particular with different detection and/or evaluation functionalities. For example, the use of a computer tomograph for the primary detection system and X-ray diffraction analysis for the secondary detection system is possible within the scope of the present disclosure.

Further advantages can be achieved if, in a method according to the disclosure, different detection methods are used for the primary detection system and the secondary detection system, in particular an X-ray diffraction method for the secondary detection system. As already explained in the previous paragraph, different detection methods with different detection accuracies, different detection specialities and, above all, different detection speeds can be used. The primary detection system may have a higher detection speed than the secondary detection system. Conversely, the secondary detection system may serve to provide a higher detection accuracy than the primary detection system and/or an increased accuracy in a weak detection range of the primary detection system. The combination of fast primary detection and accurate secondary detection further increases the advantages of a method according to the disclosure in terms of optimising the number of items of luggage per unit of time while maintaining and/or increasing detection security for alarm objects.

It can be advantageous if, in a method according to the disclosure, the at least one alarm object parameter is selected from one of the following:
position of the alarm object in the item of luggage,
orientation of the alarm object in the item of luggage,
size of the alarm object,
geometry of the alarm object,
presence of an alarm object,
number of multiple alarm objects,
nature of the alarm object.

The above list is non-exhaustive. Naturally, two or more alarm object parameters can also be used together in the method according to the disclosure. The simplest case is the presence of an alarm object or a number of several alarm objects. Thus, in this embodiment the general presence of one or more alarm objects causes the secondary detection method to be performed. In most cases however, at least one additional alarm object parameter is used which for example includes the position of the alarm object in the item of luggage. The position, orientation, type, proximity or similar information relating to adjacent content objects in relation to the alarm object in the item of luggage can also in principle be used as alarm object parameters. If the geometry of the alarm object is used, a flat extension can for example be distinguished from a compact form. It is also possible to use parameters such as the outer packaging, the density or the structure of the alarm object as alarm object parameters. The nature of the alarm object can, for example, reflect the physical state of the alarm object. The subsequent adaptation of at least one detection parameter within the method can for example be carried out on the basis of predefined lists or correlations. It is also possible that an algorithmic consideration, and thus an algorithmic relationship between the at least one alarm object parameter and the corresponding adaptation of a correlated detection parameter, is used.

In addition, an advantage can be achieved if, in a method according to the disclosure, the at least one detection parameter influences the statistical quality of the secondary detection method, in particular being selected from one of the following:
belt speed of a conveyor belt conveying the item of luggage through the secondary detection system,
operating parameters of at least one X-ray source, in particular its voltage and/or current,
quantity of X-ray sources to be used,
operating frequency of at least two X-ray sources,
operating strength of at least two X-ray sources.

The above list is non-exhaustive. Here too, a combination of two or more different detection parameters is of course also possible. It is also conceivable that different alarm object parameters influence different detection parameters twice.

In general, it is thus now possible to adapt to the nature, size or, for example, the material property of the alarm object, so that the belt speed of the conveyor belt and/or other operating parameters can be adapted. In particular, two core ideas of the detection parameters are influencing the speed of detection and/or detection accuracy. For example, the different mode of operation of an X-ray source can make it possible to vary how many photons per unit of time and/or per unit area pass through an item of luggage. If, for example, greater accuracy is required, by increasing the quantity of photons per unit of time and/or per unit area the item of luggage can pass through the secondary detection with higher detection accuracy with the same detection speed and/or with higher detection speed with the same detection accuracy. A wide variety of qualities can be taken into account. In addition to the already-explained quantity of photons per unit of time, the quantity of photons per unit area can also be taken into account by centring or focusing the X-rays. If two or more X-ray sources are used, their positioning and thus their beam path can be taken into account in the adaptation of the detection parameters. Different X-ray sources can, accordingly, also be switched on and off in succession more quickly or less quickly. The actual operating strength of an X-ray source can also quantitatively influence the quantity of photons.

It is also advantageous if, in a method according to the disclosure, to improve statistical detection quality, the quantity of photons is influenced in the second detection method, in particular adapted to a quantity of photons required for the alarm object detected in the primary detection method. In particular, this involves an X-ray diffraction analysis as a second detection method. For example, depending on the material, the material-dependent quantity of photons required for secondary detection can be stored as an alarm object parameter in characteristic diagrams or lists. This quantity and the associated quantitative detection parameter can also be provided with a security margin in order to be able to carry out the secondary detection method with even greater security. A cross-influencing of several alarm object parameters for different detection parameters, as has already been explained, is also conceivable. Of course it is advantageous, especially with regard to the quantity of photons in the second detection method, if the actual quantity of photons which is emitted by the respective X-ray source and/or is detected at the respective detector is determined and reflected back into the method according to the disclosure. In this way, a control loop for the secondary detection method can be provided.

Further advantages can be achieved if, in a method according to the disclosure, the at least one detection parameter influences the spatial resolution of the secondary detection method, in particular being selected from one of the following:
focusing,
diffraction angle,
primary and/or secondary collimation,
spatial resolution of a detection device.

The above list is non-exhaustive. Here too, an adaptation to the size, thickness, geometric extension, material and/or proximity to other objects within the item of luggage as an alarm object parameter is again the starting point for the adaptation of the detection parameters. In addition to the already-explained use of lists or characteristic diagrams, there may also be an algorithmic correlation. In addition to the actual performance of the physical detection method, an adaptation of the evaluation algorithm is of course conceivable, in addition or alternatively, within the scope of the present disclosure, via a detection method. For example, if an X-ray source is used as a secondary detection system, the focusing can be changed for this X-ray source. The changing of collimation situations, resolutions into a spatial view or the variation of diffraction angles is also in principle conceivable here.

It can also be advantageous if, in a method according to the disclosure, the at least one detection parameter influences the detection resolution of the secondary detection method, in particular being selected from one of the following:
focusing,
scattering angle,
primary and/or secondary collimation,
energetic resolution of a detector device.

The above list is also non-exhaustive. The detection resolution includes in particular detection parameters that influence the resolution of the detection result.

For example, a sharper focus achieves a detection result which is more detailed and thus formed with a higher detection resolution.

Here too, the detection parameter is again adapted on the basis of different materials, in particular the difference between crystalline materials and liquids in the alarm object. For example, in an X-ray diffraction analysis, crystalline materials, in contrast to liquids, exhibit exact and sharply distinguishable intensity maxima in an energy-resolved spectrum. Liquids therefore have to be examined much less precisely, since in effect they have a broader and thus less precisely delineated form with regard to the energy-resolving result diagrams, also known as fingerprints.

Further advantages can be achieved if, in a method according to the disclosure, a lower limit and/or upper limit specific to the respective detection parameter is adhered to in the adaptation of the at least one detection parameter. For example, there may be detection parameters beyond which meaningful detection is no longer possible. For example, a minimum quantity of photons is necessary to obtain a reasonably evaluable result per unit area and/or unit of time in an X-ray diffraction analysis. This minimum quantity of photons can represent a lower limit for the detection parameter. In particular, the correspondingly associated time for carrying out the secondary detection step must be taken into account as an upper limit. For example, a maximum time requirement can be specified which must not be exceeded when adapting the respective detection parameter. If exceeding this limit cannot be avoided, on the basis of the detected alarm object parameter, this item of luggage must for example be examined manually in order not to interfere with the process in a baggage handling system.

It is also advantageous if, in a method according to the disclosure, for the secondary detection method, an energy-resolving detector device is arranged in the secondary detection system to measure an energy spectrum. Here too, reference is made in particular to an X-ray diffraction analysis. The measurement of an energy spectrum allows the respective energy to be plotted on the X-axis and the corresponding amount of photons on the Y-axis in an energy-resolving manner. Such an energy spectrum can also be referred to as a fingerprint, as such energy spectra are very specific to a corresponding material. Although they do not take into account either the shape or geometry of an alarm object, they can provide very precise information about the material properties. In this way, in combination with the possibilities for primary detection methods already explained, they represent a very good addition to increase the security of the detection of alarm objects even further. The evaluation of such energy spectra may be carried out automatically with the help of a downstream algorithm, but can also be carried out manually, specifically for defined materials, by comparing an energy spectrum with correspondingly correlating other energy spectra.

It is also advantageous if, in a method according to the disclosure, if no alarm object is detected in the primary detection method, the further steps are omitted. In other words, a bypass can be provided in the detection device which completely bypasses the secondary detection stage in the case of an item of luggage that is free of an alarm object. Alternatively, it is also possible that the secondary detection is always carried out with a minimum of time expenditure in order to ensure at least a minimum of secondary detection results for each item of luggage. In both cases, a maximisation of the throughput of items of luggage through an entire detection device per unit of time can be achieved.

Another advantage is achievable if, in a method according to the disclosure, a primary detection result of the primary detection method is taken into account when evaluating the secondary detection result of the secondary detection method. For example, indications of possible types of an alarm object can narrow down the evaluation of the secondary detection result, so that the evaluation can take place more quickly, with greater accuracy and/or with less computational effort. It is also possible to take this into account in a visual way, so that, for example, a visual evaluation of a primary detection result can be overlaid with a fingerprint according to the energy spectrum already described. This makes false alarms even more likely to be prevented and further increases security when using a method according to the disclosure.

It also brings advantages if, in a method according to the disclosure, a position detection of the alarm object detected in the primary detection method is performed before the secondary detection method is performed. Such a position detection makes it possible to determine whether there may have been a change in the orientation of the item of luggage. In addition to a repositioning of the item of luggage into a different starting position than when the primary detection method was carried out, a corresponding adaptation to this changed position can also be made when performing the secondary detection method with reference to the position of the alarm object. This is also the case if, not only has the item of luggage been arranged with a different orientation, but the alarm object has also shifted or rotated due to movements within the item of luggage. Such a position detection can for example be ensured by an additional X-ray procedure directly before the secondary detection system.

The subject matter of the present disclosure also includes a computer program product comprising commands which, when the program is run by a computer, cause it to carry out the steps of a method according to the disclosure. Thus, a computer program product according to the disclosure brings the same advantages as have been explained in detail with reference to a method according to the disclosure.

A further subject matter of the present disclosure is a detection device for detecting alarm objects in items of luggage. Such a detection device has a primary detection system for carrying out a primary detection method for detecting alarm objects. Furthermore, the detection device is equipped with a secondary detection system for carrying out a secondary detection method for detecting alarm objects. A control unit is provided with a transfer module for transferring at least one alarm object parameter to the secondary detection system in the event of an alarm object being detected in the primary detection method. Furthermore, the control unit is equipped with an adaptation module for adapting at least one detection parameter of the secondary detection system on the basis of the alarm object parameter. The transfer module and/or the adaptation module are in particular designed to carry out a method according to the disclosure. Thus, a detection device according to the disclosure brings the same advantages as have been explained in detail with reference to a method according to the disclosure. In the detection device according to the disclosure, the primary detection system and the secondary detection system can be either separate or combined, in particular in a common housing. For example, the adaptation module described above may have a primary collimator which allows focusing, alignment and/or bundling of electromagnetic radiation.

Further advantages, features and details of the disclosure are explained in the following description, in which embodiments of the disclosure are described in detail with reference to the drawings. The features mentioned in the claims and in the description may in each case be essential to the disclosure individually or in any combination. In each case schematically:

### BRIEF DESCRIPTION OF THE DRAWINGS

FIG. 1 shows an embodiment of a detection device according to the disclosure in the first step of a method according to the disclosure,

FIG. 2 shows the embodiment of FIG. 1 when passing through the primary detection method,

FIG. 3 shows the method according to the disclosure during the adaptation of at least one detection parameter,

FIG. 4 shows the detection device of FIGS. 1 to 3 when performing the secondary detection method,

FIG. 5 shows a possibility of an energy spectrum for water,

FIG. 6 shows a possibility for an energy spectrum for propanol,

FIG. 7 shows a possibility of an energy spectrum for plastics,

FIG. 8 shows the possibility of an energy spectrum for drugs and

FIG. 9 shows a further embodiment of a detection device according to the disclosure.

### DETAILED DESCRIPTION

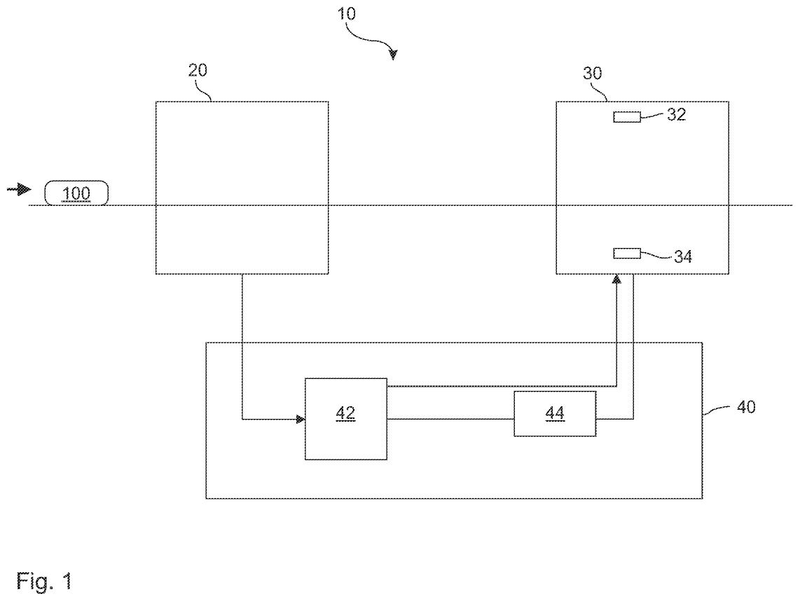

FIG. 1 shows schematically a detection device 10 as well as the procedure of a method according to the disclosure in FIGS. 1, 2, 3 and 4. Both the detection device 10 and also the procedure of a method according to the disclosure will now be explained in more detail with reference to these four figures.

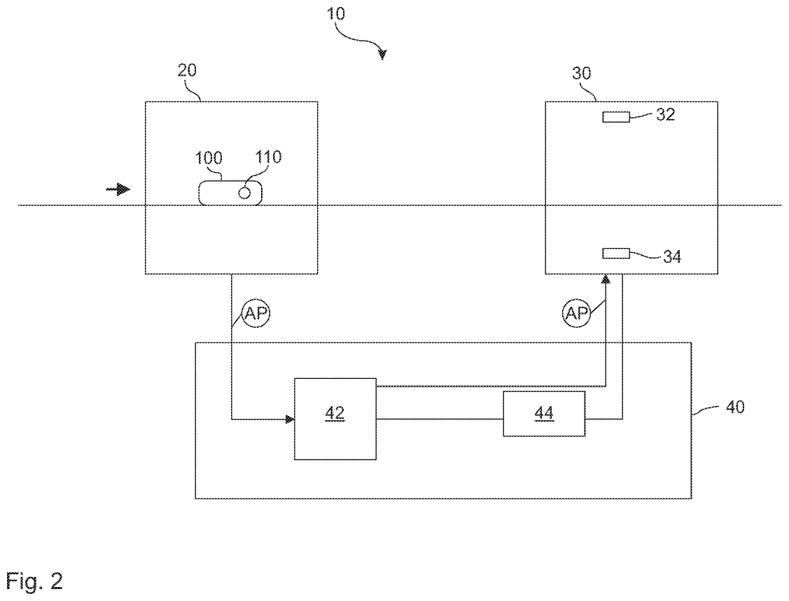

On a conveyor belt, represented schematically, an item of luggage 100 is transported along the direction of the arrow in FIG. 1. The item of luggage 100 is thus introduced into the primary detection system 20 which, for example, has a computer tomography functionality. Scanning with electromagnetic radiation makes it possible to detect an alarm object 110 in the item of luggage 100, as shown in FIG. 2. For example, this can be suspected explosives, a weapon or prohibited materials. The information about the alarm object 110 is now transferred as at least one alarm object parameter AP to a transfer module 42 of the control unit 40, as shown in FIG. 2. In a first step, this alarm object parameter AP is also transferred to the secondary detection system 30 without further processing. In the simplest case, this leads to the detection of the alarm object 110 activating the secondary detection system 30 for a second check and thus to carry out the secondary detection method, or to a detection parameter being changed.

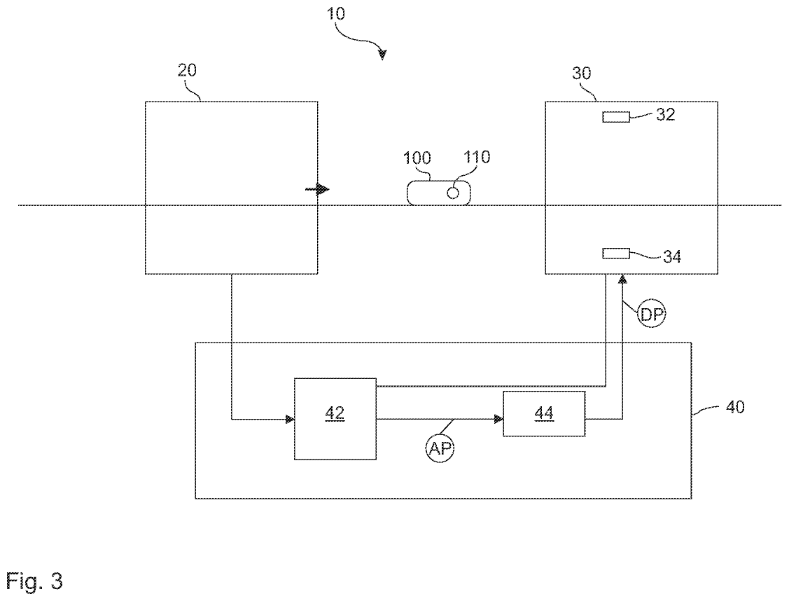

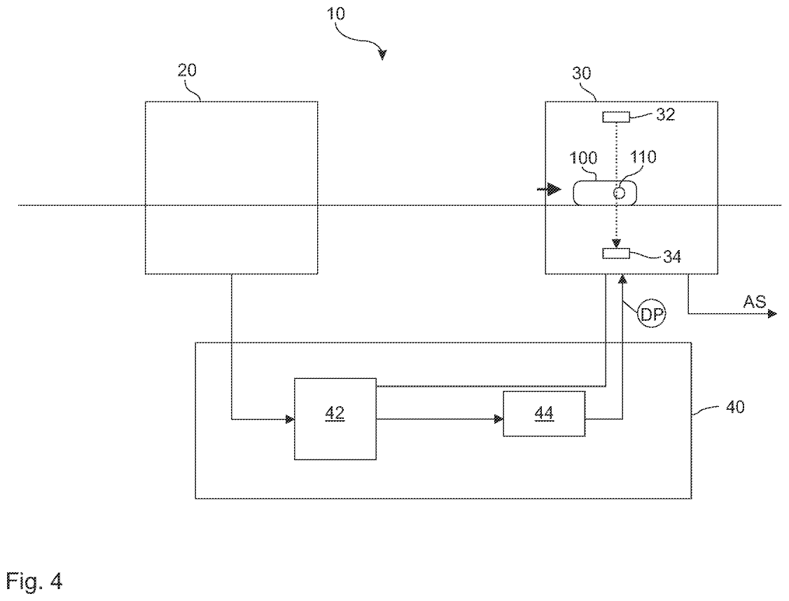

FIG. 3 shows the intermediate step between the two detection methods. While the item of luggage 100 moves to the secondary detection system 30 together with the alarm object 110 detected in it, within the control unit 40 in the transfer module 42 the at least one alarm object parameter AP is also transferred to an adaptation module 44. Lists, characteristic diagrams or other correlations are for example stored in this adaptation module 44 which adapt operating modes of the secondary detection system 30 depending on certain alarm object parameters AP. For this adaptation, the adaptation module 44 outputs at least one detection parameter DP which is transferred to the secondary detection system 30. For example, the alarm object 10 may contain an indication of a material that needs to be examined more closely. For example, a distinction between different materials is necessary, which requires that individual, different and closely spaced peaks in an energy spectrum can be assigned exactly to one energy level. To ensure this, a larger amount of photons per unit area is for example necessary. In such an embodiment, the associated detection parameter DP specifies, for example, that a larger quantity of photons per unit of time and/or per unit area can be emitted by the X-ray source 32 or allowed to pass through the downstream collimator system (not shown in the figures) and can be received accordingly by the detection device 34. This is in particular done so as to be limited locally to the area of the item of luggage 100 in which the alarm object 110 is arranged, as shown in FIG. 4. Depending on the result of this check, an alarm signal AS can then finally be output, or not.

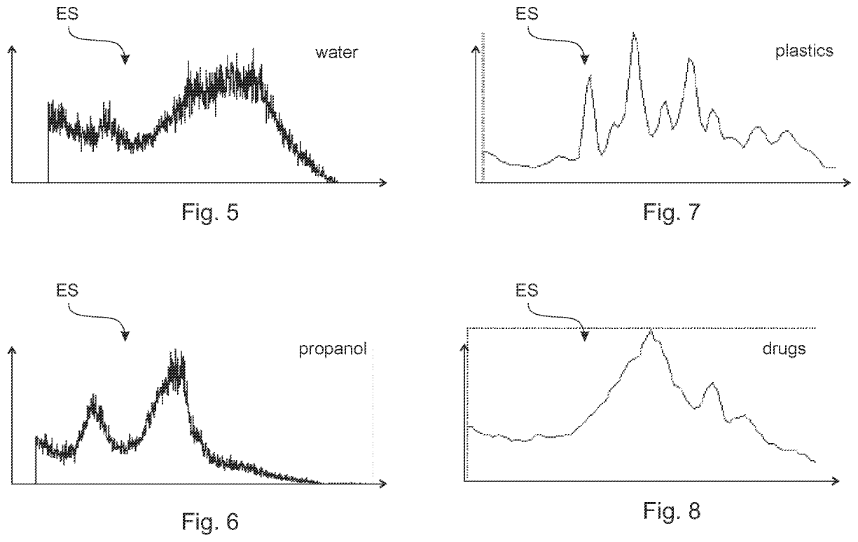

FIGS. 5 to 8 show schematic energy spectra ES which represent the secondary detection result when using X-ray diffraction analysis. While FIGS. 5 and 7 depict harmless substances such as water or plastic, FIGS. 6 and 8 show a representation of hazardous materials that should not be loaded into the cargo hold of an aircraft. Here, it can also clearly be seen how, not only do the individual energy spectra ES, which can be described as fingerprints, differ in their basic representation of the peaks, they also differ in the actual number of peaks and, accordingly, the necessary fineness with regard to the level of detail in the measurement of these energy spectra ES. To achieve a detailed differentiation, correspondingly finer degrees of differentiation are necessary for FIGS. 5 and 6 and thus a higher resolution for a secondary detection method than is necessary in the case of the relatively roughly distinguishable energy spectra ES of FIGS. 7 and 8. Accordingly, if there are indications of the respective material, the necessary energy detection parameters DP for the secondary detection method can also be adapted accordingly.

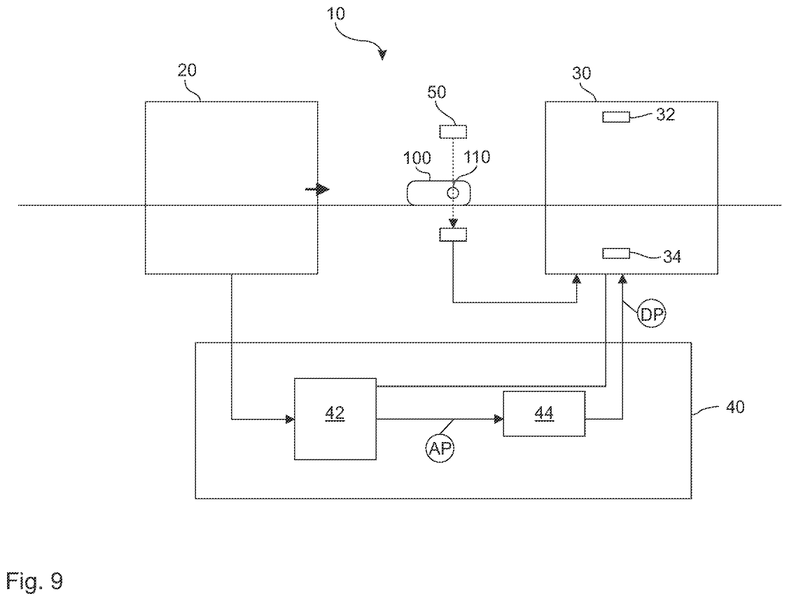

Finally, FIG. 9 shows schematically how a positioning system 50 can be integrated between the two detection systems 20 and 30. This makes it possible to recognise a change in the positioning of the alarm object 110 within the item of luggage 100, and/or relative to the conveyor system, and pass this on to the secondary detection system 30. In particular, if the secondary detection method is to be limited to the area of the item of luggage 100 in which the alarm object 110 has been detected, this can bring great advantages and in particular avoid areas of the item of luggage areas being scanned which, due to a change in the relative position of the alarm object 110, no longer contain this at all.

The above explanation of the embodiments describes the present disclosure exclusively in the context of examples. Naturally, individual features of the embodiments can, where technically expedient, be combined freely with each other without departing from the scope of the present disclosure.

1. A method for detecting alarm objects
in items of luggage by means of a primary detection system and a secondary detection system, having the following steps:
carrying out a primary detection method by means of the primary detection system to detect at least one alarm object;
transferring at least one alarm object parameter (AP) to the secondary detection system in the event of an alarm object being detected in the primary detection method;
adapting at least one detection parameter (DP) of the secondary detection system on the basis of the alarm object parameter (AP);
carrying out a secondary detection method by means of the secondary detection system with adapted at least one detection parameter (DP) in order to check the alarm object detected in the primary detection method; and
outputting an alarm signal (AS) in the event that the checking of the alarm object proves positive.

2. A method according to claim 1, wherein in the primary detection system and in the secondary detection system the items of luggage are scanned by means of electromagnetic radiation.

3. A method according to claim 1, wherein different detection methods are used for the primary detection system and the secondary detection system, in particular an X-ray diffraction method for the secondary detection system.

4. A method according to claim 1, wherein the at least one alarm object parameter (AP) is selected from one of the following:
position of the alarm object in the item of luggage;
orientation of the alarm object in the item of luggage;
size of the alarm object;
geometry of the alarm object;
presence of an alarm object;
number of multiple alarm objects; and
nature of the alarm object.

5. A method according to claim 1, wherein the at least one detection parameter (DP) influences the statistical quality of the secondary detection method, in particular being selected from one of the following:
belt speed of a conveyor belt conveying the item of luggage through the secondary detection system;
operating parameters of at least one X-ray source, in particular its voltage and/or current;
quantity of X-ray sources to be used;
operating frequency of at least two X-ray sources; and
operating strength of at least two X-ray sources.

6. A method according to claim 5, wherein, for statistical quality, the quantity of photons is influenced in the second detection method, in particular adapted to a quantity of photons required for the alarm object detected in the primary detection method.

7. A method according to claim 1, wherein the at least one detection parameter (DP) influences the spatial resolution of the secondary detection method, in particular being selected from one of the following:
focusing;
diffraction angle;
primary and/or secondary collimation; and
spatial resolution of a detection device.

8. A method according to claim 1, wherein the at least one detection parameter (DP) influences the detection resolution of the secondary detection method, in particular being selected from one of the following:
focusing;
scattering angle;
primary and/or secondary collimation; and
energetic resolution of a detector device.

9. A method according to claim 1, wherein, when adapting the at least one detection parameter (DP), a lower limit and/or upper limit specific to the respective detection parameter (DP) is complied with.

10. A method according to claim 1, wherein, for the secondary detection method, an energy-resolving detector device is arranged in the secondary detection system to measure an energy spectrum (ES).

11. A method according to claim 1, wherein, if no alarm object is detected in the primary detection method, the further steps are omitted.

12. A method according to claim 1, wherein a primary detection result of the primary detection method is taken into account when evaluating the secondary detection result of the secondary detection method.

13. A method according to claim 1, wherein a position detection of the alarm object detected in the primary detection method is performed before the secondary detection method is carried out.

14. A computer program product comprising commands which, when the program is run by a computer, cause it to carry out the steps of a method having the features of claim 1.

15. A detection device for detecting alarm objects in items of luggage, having a primary detection system for carrying out a primary detection method for detecting alarm objects and a secondary detection system for carrying out a secondary detection method for detecting alarm objects, further having a control unit with a transfer module for transferring at least one alarm object parameter (AP) to the secondary detection system in the event of an alarm object being detected in the primary detection method and an adaptation module for adapting at least one detection parameter (DP) of the secondary detection system on the basis of the alarm object parameter (AP), wherein the transfer module and/or the adaptation module are in particular designed to carry out a method with steps of claim 1.
